(19) United States
(12) Patent Application Publication
(10) Pub. No.: US 2011/0012934 A1
(43) Pub. Date: Jan. 20, 2011

(54) DISPLAY APPARATUS WITH ANTI-INTERFERENCE OF RESONANCE AND METHOD THEREOF

(75) Inventor: Bomin WENG, Sanchong City (TW)

Correspondence Address: VOLPE AND KOENIG, P.C., UNITED PLAZA, 30 SOUTH 17TH STREET, PHILADELPHIA, PA, 19103, US

(73) Assignee: HANNSTAR DISPLAY CORPORATION LTD., Taipei City (TW)

(21) Appl. No.: 12/756,791

(22) Filed: Apr. 8, 2010

(30) Foreign Application Priority Data
Jul. 14, 2009 (TW) 098123825

(51) Int. Cl. G09G 5/00

(52) U.S. Cl. 345/690; 345/208

(57) ABSTRACT

A display apparatus is provided. The display comprises a system module responding to a first frequency to output a second frequency, wherein a magnitude of the second frequency is not an integer multiple of that of the first frequency. The system module comprises a detection circuit detecting the first frequency of the vertical synchronous signal, and a processor producing a plurality of adjacent integers. The display apparatus further comprise an internal light source providing a back light for the display apparatus to display an image, and a light source control module responding to an intermittent pulse to output a drive pulse to the internal light source for controlling one of an operation on and an operation off of the internal light source, wherein the display apparatus prevents the drive pulse from interfering with the image by using the intermittent pulse.

### FIELD OF THE INVENTION

The present invention is related to a display apparatus and the operating method thereof, and more particularly to a display apparatus and the operating method thereof for preventing an image from being interfered.

### BACKGROUND OF THE INVENTION

In recent years, the flat display apparatus has gradually replaced the cathode ray tube (CRT) display apparatus due to its small size, low power consumption and low radiation. Among all the technologies of the flat display apparatus, the thin film transistor liquid crystal display (TFT-LCD) is developed very fast, and it is widely applied to various products ranged from small-sized mobile phones to large-sized LCD-TVs.

The main structure of the flat display apparatus includes a panel and a backlight module. The panel includes the conductive glasses, liquid crystals, orientation films, color filters, polarizers, drive controller, etc. The backlight module is used for illuminating images on the panel, and includes the cold cathode fluorescent light (CCFL), light emitting diode (LED), light guide plate, light source control module (i.e. inverter), and various kinds of optical thin film components. The light source control module is used for providing power to the backlight module, and a pulse generated by the light source control module is used for driving the CCFL. The light source control module converts an AC voltage into an intermittent pulse, and raises the amplitude of the voltage of the pulse to drive the CCFL.

Traditionally, there are two methods to drive the CCFL. One is the continue mode, and the other is the burst mode. The continue mode is to drive the CCFL by a continue pulse produced by the light source control module, and the burst mode is to drive the CCFL by the intermittent pulse produce by the light source control module. Please refer to FIG. 1(a), which shows the waveform of a continuous pulse. The drawback of the continue mode is that the continuous pulse 101 cannot drive the CFCC when the amplitude Apt of the continuous pulse 101 is too small, which restricts the smallest luminance of the panel. However, the burst mode does not have such drawback.

Please refer to FIG. 1(b), which shows the waveform of an intermittent pulse. Please also refer to FIG. 1(c), which shows the circuit of the light source control module in the prior art. The light source control module 3 includes a plurality of light sources 34, a power circuit 30, a control unit 31, a transformer unit 32, and a feedback unit 33. In this embodiment, the plurality of light sources 34 are two lamp tubes. In the burst mode, the pulse period d of a control signal 201 is the period illuminating with the lowest illumination, and a non-illumination period can be obtained by subtracting the pulse period d from the cycle of the intermittent pulse D. Adjusting the pulse period d and the non-illumination period can lower the luminance and increase the contrast. In practical measurement, the luminance is between 250 cd/m² and 50 cd/m² in the burst mode, and between 250 cd/m² and 180 cd/m² in the continue mode. It is obvious that the contrast in the burst mode is better than that in the continue mode.

However, the burst mode is not perfect. The intermittent pulse will interfere with the image of the panel and cause an image ripple when the frequency of the intermittent pulse is an integer multiple of the vertical synchronous frequency. In order to overcome the drawbacks in the prior art, a display apparatus with anti-interference of resonance and the method thereof are provided. The particular design in the present invention not only solves the problems described above, but also is easy to be implemented. Thus, the present invention has the utility for the industry.

### SUMMARY OF THE INVENTION

In accordance with one aspect of the present invention, a display apparatus is provided. The display apparatus comprises a system module responding to a first frequency to output a second frequency, wherein a magnitude of the second frequency is not an integer multiple of that of the first frequency.

Preferably, the first frequency is a frequency of a vertical synchronous signal, and the second frequency is a frequency of an intermittent pulse.

Preferably, the display apparatus further comprises an internal light source providing a back light for the display apparatus to display an image, and a light source control module responding to the intermittent pulse to output a drive pulse to the internal light source for controlling one of an operation on and an operation off of the internal light source, wherein the drive pulse has a frequency being equal to the second frequency.

Preferably, the light source control module operates in a burst mode to turn on the internal light source.

Preferably, the system module comprises a detection circuit detecting the first frequency of the vertical synchronous signal, and a processor producing a plurality of adjacent integers. The processor comprises a storage unit storing the first frequency of the vertical synchronous signal and the plurality of adjacent integers, and an executing unit including an arithmetic-logic unit and calculating the first frequency and the plurality of adjacent integers to generate the second frequency by using the arithmetic-logic unit, wherein the display apparatus prevents the drive pulse from interfering the image by using the intermittent pulse.

Preferably, the display apparatus is characterized by anti-interference of resonance.

Preferably, the display apparatus is a liquid crystal display apparatus, and the internal light source is a lamp tube.

Preferably, the display apparatus is a projector display apparatus, and the internal light source is a lamp tube.

In accordance with another aspect of the present invention, a system module is provided. The system module responds to a first frequency and a plurality of adjacent integers to output a second frequency, wherein a magnitude of the second frequency is not an integer multiple of that of the first frequency.

Preferably, the first frequency is a frequency of a vertical synchronous signal, and the second frequency is a frequency of an intermittent pulse.

Preferably, the second frequency is 270 Hz when the first frequency is 60 Hz.

Preferably, the second frequency is 245 Hz when the first frequency is 70 Hz.

Preferably, the second frequency is 262 Hz when the first frequency is 75 Hz.

In accordance with a further aspect of the present invention, a method for controlling a display apparatus is provided. The method comprises receiving a first signal having a first frequency, and responding to the first signal having the first frequency to output a second signal having a second frequency, wherein the second frequency has a magnitude being not an integer multiple of that of the first frequency.

Preferably, the display apparatus includes an internal light source, and the method further comprises detecting the first frequency, producing a plurality of adjacent integers, calculating the first frequency and the plurality of adjacent integers to produce the second frequency, and responding to the second signal to output a drive pulse to the internal light source for controlling one of an operation on and an operation off of the internal light source.

Preferably, the display apparatus is characterized by preventing a resonance interference.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1(a) shows the waveform of a continuous pulse;

FIG. 1(b) shows the waveform of an intermittent pulse;

FIG. 1(c) shows the circuit of the light source control module in the prior art;

FIG. 2 shows a display apparatus with anti-interference of resonance;

FIG. 3(a) shows the waveform of a vertical synchronous signal of the image 4200;

FIG. 3(b) shows the spectra of the vertical synchronous signal and the intermittent pulse;

FIG. 3(c) shows how the intermittent pulse is converted into to a drive pulse; and

FIG. 4 shows the operating flow chart of the display apparatus with anti-interference of resonance.

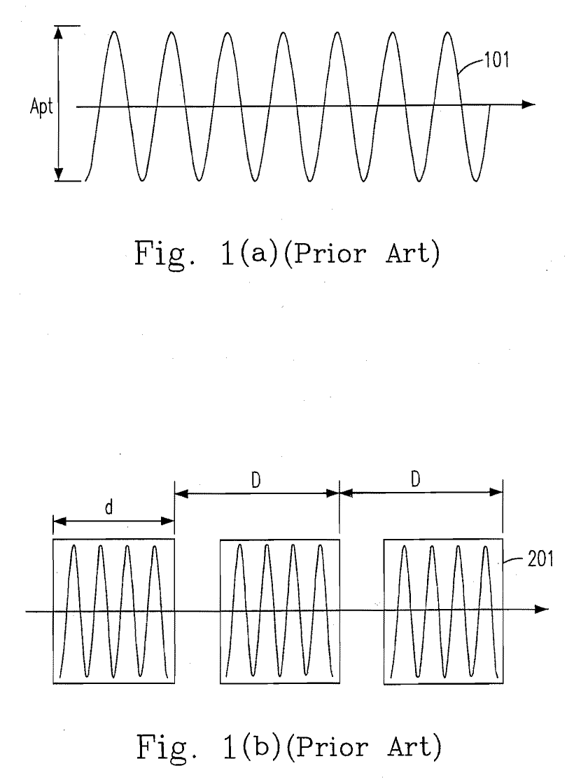

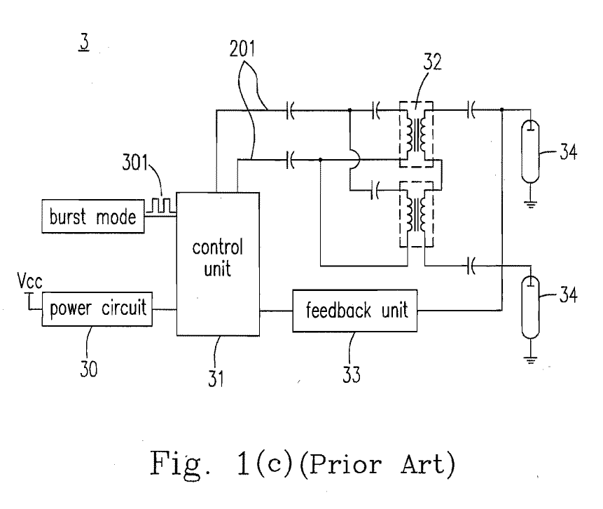

### DETAILED DESCRIPTION OF THE PREFERRED EMBODIMENT

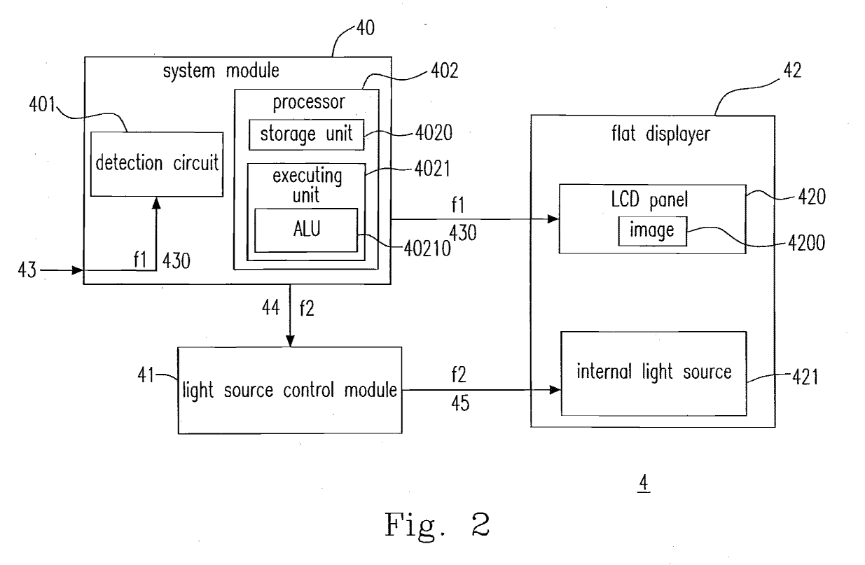

Please refer to FIG. 2, which shows a display apparatus with anti-interference of resonance. The display apparatus with anti-inference of resonance 4 is used for displaying an image 4200 without being interfered. The display apparatus with anti-inference of resonance 4 comprises a system module 40, a light source control module 41, and a flat display 42. The flat display 42 comprises an LCD panel 420 and an internal light source 421, and the image 4200 is displayed on the LCD panel 420. The system module 40 comprises a detection circuit 401 and a processor 402, wherein the detection circuit 401 detects a display scan frequency. The processor 402 comprises a storage unit 4020 and an executing unit 4021. The executing unit 4021 comprises an arithmetic logic unit (ALU) 40210.

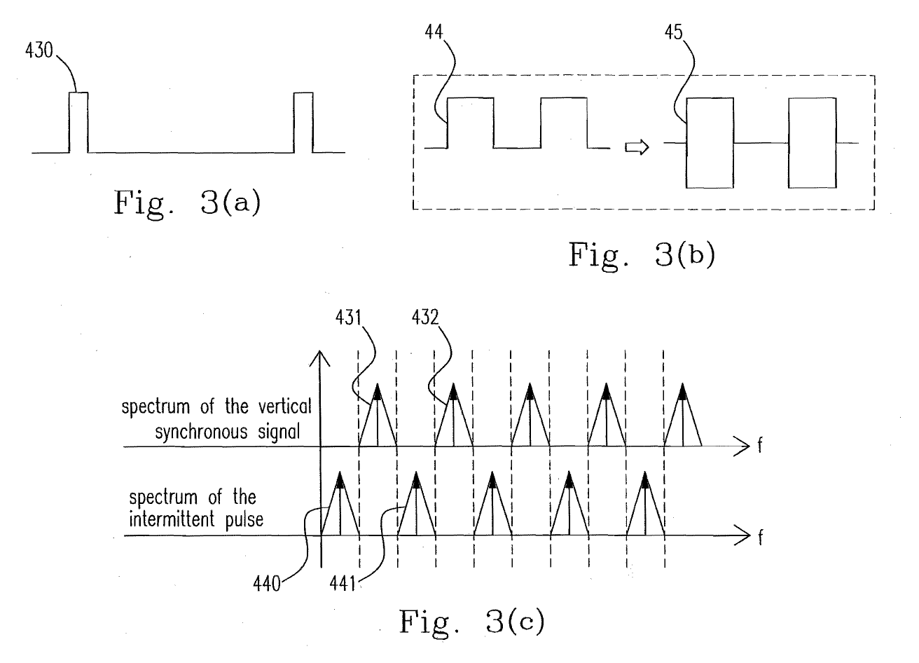

Please refer to FIG. 3(a), which shows the waveform of a vertical synchronous signal of the image 4200. In FIGS. 2, 3(a) and 3(c), the system module 40 receives an image signal 43, which includes one of a high definition multimedia interface (HDMI) signal, a digital TV (DTV) signal, a TV signal, a video graph accelerate (VGA) signal, a composite video signal, a YPbPr signal, and an SCART signal. The image signal 43 includes a vertical synchronous signal 430. The detection circuit 401 detects the vertical synchronous signal 430, and then the processor 402 stats to produce a plurality of adjacent integers. The system module 40 responds to the vertical synchronous signal 430 having a first frequency f1, and outputs an intermittent pulse 44 having a second frequency f2. The system module 40 also outputs the vertical synchronous signal 430 to the LCD panel 420 for displaying the image 4200. The storage unit 4020 stores the non-integers or the plurality of adjacent integers and the first frequency f1, and the executing unit 4021 uses the ALU 40210 to calculate the non-integers or the plurality of adjacent integers and the first frequency f1 to generate the second frequency f2, wherein the magnitude of the second frequency f2 is not an integer multiple of that of the first frequency f1.

Please refer to FIG. 3(b), which shows the spectra of the vertical synchronous signal and the intermittent pulse. The horizontal axis represents the frequency, and the vertical axis represents the amplitude. After fourier transforming the vertical synchronous signal 430 and the intermittent pulse 44, one-fold frequency band 431 of the vertical synchronous signal 430, two-fold frequency band 432 of the vertical synchronous signal 430, one-fold frequency band 440 of the intermittent pulse 44, and two-fold frequency band 441 of the intermittent pulse 44 can be obtained. Because the second frequency f2 is not an integer multiple of that of the first frequency f1, one-fold frequency band 440 of the intermittent pulse 44 doesn't cover one-fold frequency band 431 of the vertical synchronous signal 430, and two-fold frequency band 441 of the intermittent pulse 44 doesn't cover two-fold frequency band 432 of the vertical synchronous signal 430. For the same reason, three-fold frequency band or above of the intermittent pulse 44 doesn't cover three-fold frequency band or above of the vertical synchronous signal 430. This means the intermittent pulse 44 having the second frequency f2 doesn't interfere with the vertical synchronous signal 430.

Please refer to FIG. 3(c), which shows how the intermittent pulse is converted into a drive pulse. In FIGS. 2 and 3(c), the light source control module 41 operates in the burst mode, and responds to the intermittent pulse to output a drive pulse 45 to the internal light source 421 for controlling an operation on or an operation off of the internal light source 421. The drive pulse 45 has a frequency being equal to the second frequency f2, and the display apparatus with anti-interference of resonance 4 prevents the drive pulse 45 from interfering with the image 4200 by converting the intermittent pulse 44 into the drive pulse 45. The root-mean-square value of the drive pulse 45 depends on the size of the LCD panel 420. For example, the root-mean-square value of the drive pulse 44 is 400 volt for a 15-inch LCD panel. The larger the size of the LCD panel 420 is, the larger the root-mean-square value of the drive pulse 44 is. The light source control module 41 is a module for increasing the magnitude of the root-mean-square value of the drive pulse 44.

In FIG. 2, the image signal 43 is processed by the system module 40 and then output to the LCD panel 420. The image signal 43 includes the horizontal synchronous signal (not shown), control signal (not shown), pixel data signal (not shown), and vertical synchronous signal 430. The vertical synchronous signal 430 is related to the quality of a frame. Therefore, preventing the vertical synchronous signal 430 from being interfered can prevent the image ripple efficiently. The LCD panel 420 of the flat display 42 receives the vertical synchronous signal 430 to drive the LCD panel 420 and display the image 4200. The internal light source 421 of the flat display 42 receives and is driven by the drive pulse 45 to illuminate the LCD panel 420, wherein the frequency when the internal light source 421 is turned on equals the second frequency f2. Hence, the drive pulse 45 will not interfere with the image 4200.

The embodiments of the present invention are described as follows. Please also refer to FIG. 2. In a first embodiment, the system module 40 responds to the vertical synchronous signal 430 having the first frequency 60 Hz and the plurality of adjacent integers to output the intermittent pulse 44 having the second frequency 270 Hz. In a second embodiment, the system module 40 responds to the vertical synchronous signal 430 having the first frequency 70 Hz and the plurality of adjacent integers to output the intermittent pulse 44 having the second frequency 245 Hz. In a third embodiment, the system module 40 responds to the vertical synchronous signal 430 having the first frequency 75 Hz and the plurality of adjacent integers to output the intermittent pulse 44 having the second frequency 262 Hz. In the above embodiments, the internal light source 421 includes at least one lamp tube, and the display apparatus with anti-interference of resonance 4 can be an LCD, a back projector apparatus or a projector apparatus.

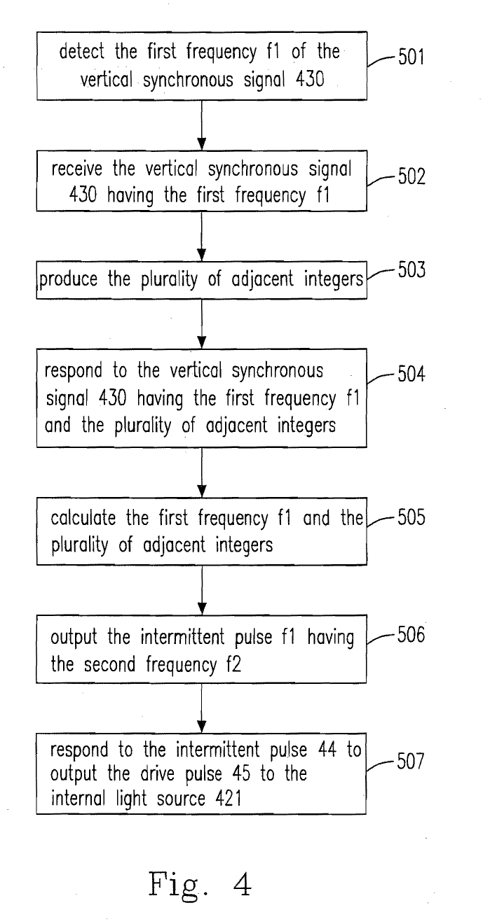

Please refer to FIG. 4, which shows the operating flow chart of the display apparatus with anti-interference of resonance 4. In step 501, the detection circuit 401 detects the first frequency f1 of the vertical synchronous signal 430, and the system module 40 bypasses the image signal 43 to the LCD panel 420. In step 502, the LCD panel 420 receives the vertical synchronous signal 430 having the first frequency f1 to drive the LCD panel 420 and display the image 4200. However, in order to display the image 4200, the internal light source 421 needs to be provided to illuminate the LCD panel 420. In step 503, the processor 402 produces the plurality of adjacent integers, such as two adjacent integers. In step 504, the processor 402 responds to the vertical synchronous signal 430 having the first frequency f1 and the plurality of adjacent integers. In step 505, the ALU 40210 calculates the first frequency f1 and the plurality of adjacent integers by an algorithm. For example, the first frequency f1 is multiplied by two adjacent integers to obtain two other frequencies, and then the processor 402 adds these two frequencies to obtain a value and divides the value by two to obtain a second frequency f2. The magnitude of the second frequency f2 is not an integer multiple of that of the first frequency f1. In step 506, the system module 40 outputs the intermittent pulse 44 having the second frequency f2. In step 507, the light source control module 41 responds to the intermittent pulse 44 to output the drive pulse 45 to the internal light source 421. The frequency of the drive pulse 45 depends on the intermittent pulse 44, and the drive pulse 45 can be regarded as the intermittent pulse 44 with a voltage enhancement. That is, the frequency of the drive pulse 45 is the second frequency f2. Therefore, the drive pulse 45 will not interfere with the image 4200 when the internal light source 421 is turned on thereby.

The present invention can adjust the second frequency f2 automatically in real time according to the first frequency f1, and thus the alteration or adjustment in hardware components or circuits is not required.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A display apparatus, comprising:
a system module responding to a first frequency to output a second frequency, wherein a magnitude of the second frequency is not an integer multiple of that of the first frequency.

2. A display apparatus as claimed in claim 1, wherein the first frequency is a frequency of a vertical synchronous signal, and the second frequency is a frequency of an intermittent pulse.

3. A display apparatus as claimed in claim 2, further comprising:
an internal light source providing a back light for the display apparatus to display an image; and
a light source control module responding to the intermittent pulse to output a drive pulse to the internal light source for controlling one of an operation on and an operation off of the internal light source, wherein the drive pulse has a frequency being equal to the second frequency.

4. A display apparatus as claimed in claim 3, wherein the light source control module operates in a burst mode to turn on the internal light source.

5. A display apparatus as claimed in claim 3, wherein the system module comprises:
a detection circuit detecting the first frequency of the vertical synchronous signal; and
a processor producing a plurality of adjacent integers, and including:
a storage unit storing the first frequency of the vertical synchronous signal and the plurality of adjacent integers; and
an executing unit including an arithmetic-logic unit and calculating the first frequency and the plurality of adjacent integers to generate the second frequency by using the arithmetic-logic unit,
wherein the display apparatus prevents the drive pulse from interfering the image by using the intermittent pulse.

6. A display apparatus as claimed in claim 1, characterized by anti-interference of resonance.

7. A display apparatus as claimed in claim 1, being a liquid crystal display apparatus, wherein the internal light source is a lamp tube.

8. A display apparatus as claimed in claim 1, being a projector display apparatus, wherein the internal light source is a lamp tube.

9. A system module, responding to a first frequency and a plurality of adjacent integers to output a second frequency, wherein a magnitude of the second frequency is not an integer multiple of that of the first frequency.

10. A system module as claimed in claim 9, wherein the first frequency is a frequency of a vertical synchronous signal, and the second frequency is a frequency of an intermittent pulse.

11. A system module as claimed in claim 10, comprising:
a detection circuit detecting the first frequency of the vertical synchronous signal; and
a processor, including:
a storage unit storing the first frequency of the vertical synchronous signal and the plurality of adjacent integers; and
an executing unit including an arithmetic-logic unit, and calculating the first frequency and the plurality of adjacent integers to generate a value of the second frequency by using the arithmetic-logic unit,
wherein the system module prevents a drive pulse from interfering an image by using the intermittent pulse.

12. A system module as claimed in claim 11, wherein the second frequency is 270 Hz when the first frequency is 60 Hz.

13. A system module as claimed in claim 11, wherein the second frequency is 245 Hz when the first frequency is 70 Hz.

14. A system module as claimed in claim 11, wherein the second frequency is 262 Hz when the first frequency is 75 Hz.

15. A method for controlling a display apparatus, comprising:
receiving a first signal having a first frequency; and
responding to the first signal having the first frequency to output a second signal having a second frequency, wherein the second frequency has a magnitude being not an integer multiple of that of the first frequency.

16. A method as claimed in claim 15, wherein the display apparatus includes an internal light source, the method further comprising:
detecting the first frequency;
producing a plurality of adjacent integers;
calculating the first frequency and the plurality of adjacent integers to produce the second frequency; and
responding to the second signal to output a drive pulse to the internal light source for controlling one of an operation on and an operation off of the internal light source.

17. A method as claimed in claim 15, wherein the second frequency is 270 Hz when the first frequency is 60 Hz.

18. A method as claimed in claim 15, wherein the second frequency is 245 Hz when the first frequency is 70 Hz.

19. A method as claimed in claim 15, wherein the second frequency is 262 Hz when the first frequency is 75 Hz.

20. A method as claimed in claim 15, characterized by preventing a resonance interference.
